(19) United States
(12) Patent Application Publication
(10) Pub. No.: US 2014/0001113 A1
(43) Pub. Date: Jan. 2, 2014

(54) FUEL FILTER

(71) Applicants: Fernando Jun Yoshino, Jundiai-SP (BR); Fabio Moreira, Sao Bernardo do Campo-SP (BR); Luiz Carlos Fritz, Indaiatuba-SP (BR)

(72) Inventors: Fernando Jun Yoshino, Jundiai-SP (BR); Fabio Moreira, Sao Bernardo do Campo-SP (BR); Luiz Carlos Fritz, Indaiatuba-SP (BR)

(73) Assignee: MAHLE METAL LEVE S.A., Sao Paulo-SP (BR)

(21) Appl. No.: 13/996,568

(22) PCT Filed: Dec. 22, 2011
(86) PCT No.: PCT/BR11/00498

§ 371 Date: Sep. 19, 2013

(30) Foreign Application Priority Data
Dec. 23, 2010 (BR) PI1005768-4

(51) Int. Cl. B01D 29/11

(52) U.S. Cl. CPC B01D 29/11
USPC 210/446

(57) ABSTRACT

The fuel filter comprises: a housing (10); a lid (20) hermetically retained against an open end (14) of the housing (10) and incorporating an outlet nozzle (21); and a tubular filter element (50) housed inside the housing (10) to define, therewith, an annular fuel admission chamber (C). The filter element (50) has its interior maintained in communication with the outlet nozzle (21) of the lid (20. The housing (10) has the open end (14) thereof provided with an outer thread (16), at least one of the parts defined by the open end (14) of the housing (10) and by the lid (20) carrying a sealing means (30) seated against the other of said parts, the filter further comprising a nut (40) to be engaged to said outer thread (16) of the housing (10) and to the lid (20), maintaining the latter hermetically seated on the housing (10).

### FIELD OF THE INVENTION

The present invention refers to a new construction for an inline filter to be applied to a fuel feed piping for different equipment and installations, being particularly suited to be assembled to the fuel feed piping of internal combustion engines such as, for example, those mounted on different types of vehicles.

### PRIOR ART

There are well known from the prior art the inline filters of the type comprising a generally cylindrical tubular housing, which houses a filter element and is provided with an inlet nozzle and an outlet nozzle which axially project from opposite ends of the tubular housing, to be connected in series to a respective fuel feed, piping of a machine or equipment. In a large number of applications, said inline filter has relatively little room, to be installed, as is the case in motor vehicles, in which the longitudinal length of the fuel piping to be replaced by the inline filter is usually small, limiting the total length of the filter. These fuel filters have each end nozzle usually built in the form of a quick coupling element, which is configured to receive a connecting element previously attached to a respective end of the fuel piping, in order to allow quick and easy filter assembly and disassembly operations in relation to said piping, which is usually of flexible material, rubber for example.

Nevertheless, the construction of the usual end nozzles causes, together with the quick coupling elements mounted on the fuel piping, a large reduction of the longitudinal length available for dimensioning the tubular housing and the filter element, and thus of its filtration capacity and lifespan, demanding more frequent replacements.

Besides leading to filters with undesirably reduced longitudinal dimension, the known end axial nozzles of the quick connect type cause a relevant head loss during the passage of the fuel through the filter, overloading the fuel pump. Thus, the progressive increase in head loss at the filter element caused by the continuous accumulation of impurities, added to the head loss on the housing nozzles, causes the opening of the valve of the return piping of the pump in an operational condition of the filter which, if not for the high head loss at the nozzles, would only occur after a longer period of operation of the filter.

Due to the constructive and dimensional characteristics of these known disposable filters and to the flow required from the fuel feed system, the fuel passes at relatively high speeds through the filter element. Consequently, impurities in the fuel tend to penetrate more intensively in the filter element and to prematurely saturate it, reducing the lifespan of the filter and requiring more frequent replacements.

These known fuel filters are further constructed with the housing formed in two tubular portions, each having a closed end, provided with a respective axial nozzle, and with an open end which is hermetically attached, usually by adhesive, to the open end of the other portion of the housing. Thus, the housing is definitely and permanently closed, with the filter element already previously mounted in its interior. When the lifespan of the filter is achieved, that is, of the filter element thereof, all the assembly is discarded, since is not possible to disassemble and replace only the filter element. The entire housing, formed in a non-degradable plastic material, for example polyamide, is discarded together with the filter element at each filter replacement operation. In short, the inline fuel filters present: a housing which is mandatorily discarded together with the filter element sealed in the interior of the housing; a relatively reduced filtration area in relation to the flow required for the fuel and to the axial dimension of the opposite nozzles and of their connections to the fuel feed piping; and also an excessive and undesirable head loss.

### SUMMARY OF THE INVENTION

Due to the inconveniences associated with the known solutions, the present invention has as one object to provide a fuel filter to be applied to a fuel feed piping in different equipment and installations and which allows, by means of a simple construction, an easy and quick replacement of the filter element only, while the tubular housing remains coupled to the feed piping on which the filter is installed.

The present invention has the further object of providing a fuel filter, such as defined above, which presents an increased filtration capacity within the same physical room for installation, and also relatively reduced head losses, allowing for a substantial increase in the lifespan of the filter element.

The present filter is of the type comprising: a housing having a tubular lateral wall, a closed end wall incorporating an inlet nozzle, and an open end; a lid hermetically retained against the open end of the housing and incorporating an outlet nozzle; and a tubular filter element having a peripheral wall defining a filtration means and being housed inside the housing, to define, together with the tubular lateral wall of the latter, an annular fuel admission chamber, said filter element having a first closed end, and a second end which is seated against the lid and communicates the interior of the filter element with the lid outlet nozzle.

According to the invention, the housing has the open end thereof provided with an outer thread and with a stop means against which the lid is seated, at least one of the parts, defined by the open end of the housing and by the lid, carrying a sealing means seated against the other of said parts. The filter further comprises a nut to be engaged to said outer thread of the housing and to the lid, maintaining the latter hermetically seated on the housing and retained against the stop means.

With the above mentioned construction, when the filter element achieves its lifespan, it is only necessary to disassemble the lid from the housing by means of the simple release turn of the nut, thereby allowing the filter element to be removed from within the housing and replaced by a new filter element, which is taken to its operational condition by the simple assembly of the lid on the open end of the housing and by the closing turn of the nut over the outer thread of the open end of the housing. These operations, necessary to replace the filter element, are carried out without having to disengage the inlet and outlet nozzles in relation to the respective sections of the fuel feed piping.

### BRIEF DESCRIPTION OF THE DRAWINGS

The invention will be described below, with reference to the enclosed drawings, given by way of example of the possible embodiments of the invention and in which:

FIG. 1 represents an exploded perspective view of the filter of the present invention;

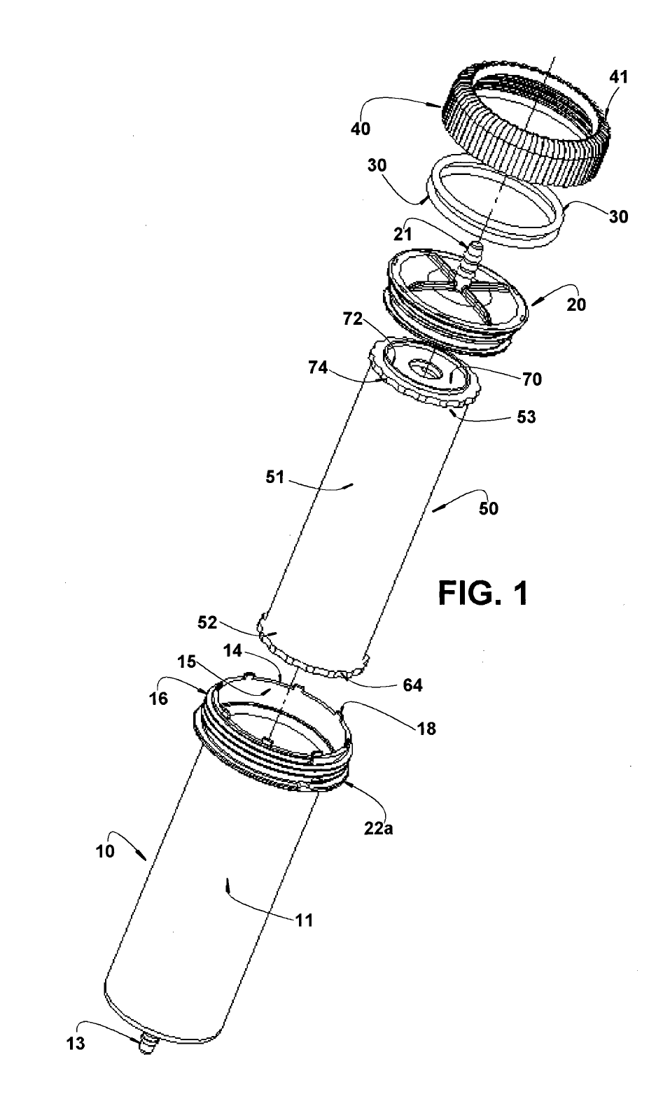

FIG. 2 represents an enlarged exploded view of the lid and of the upper portion of the housing illustrated in FIG. 1;

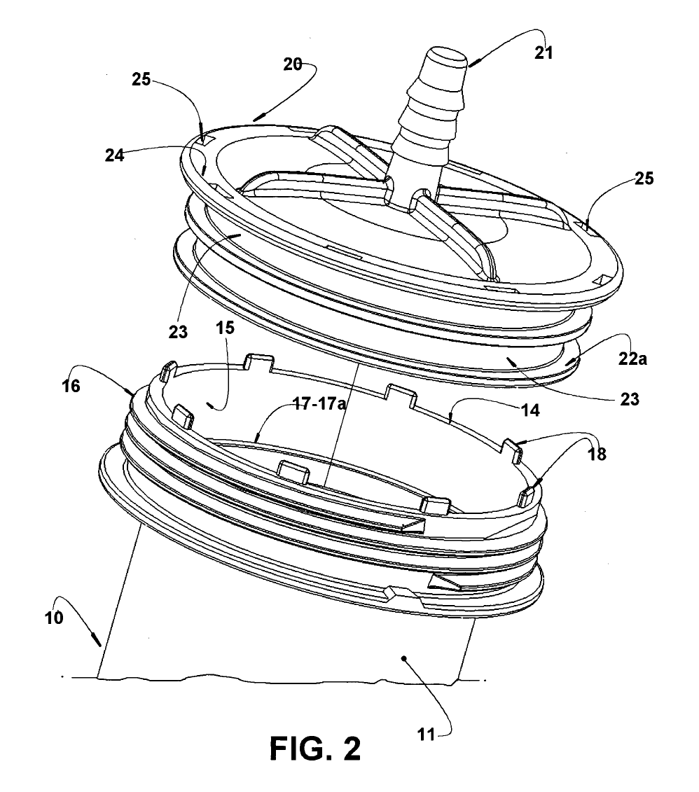

FIG. 3 represents a bottom perspective view of the filter element;

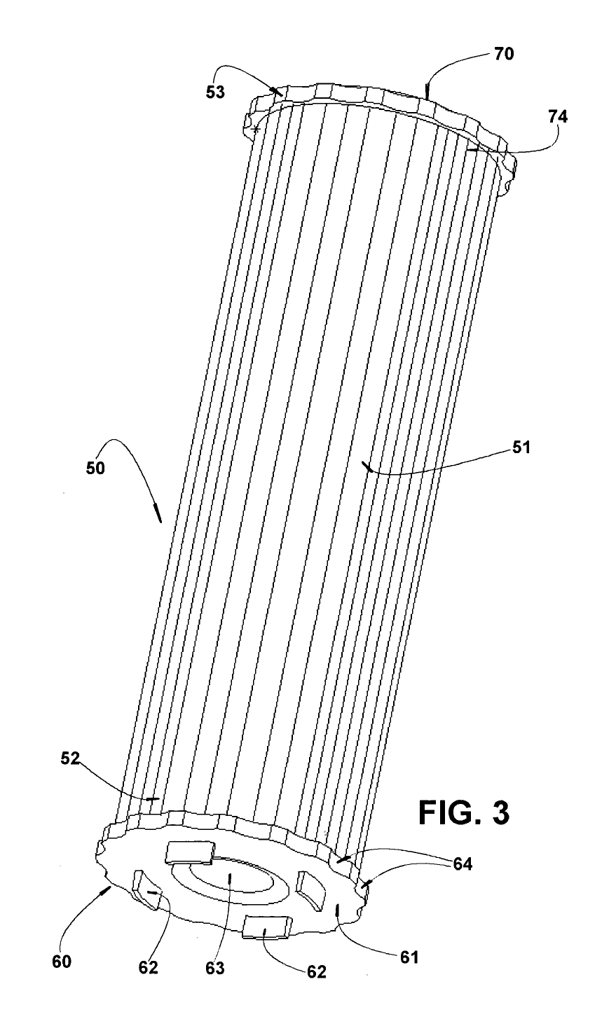

FIG. 4 represents a longitudinal diametral cross-sectional view of the present filter;

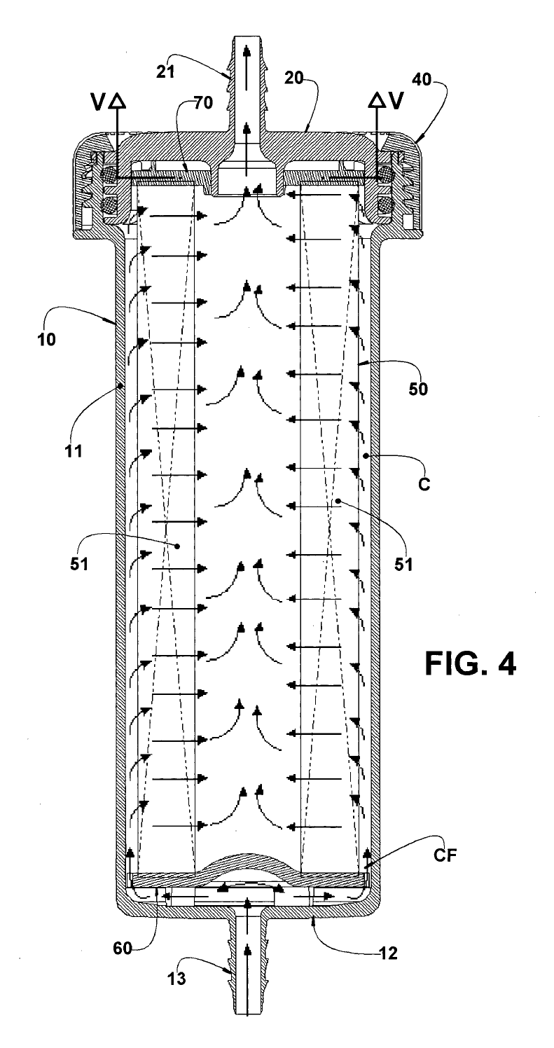

FIG. 5 represents a cross-sectional view of the filter, taken along line V-V in FIG. 4;

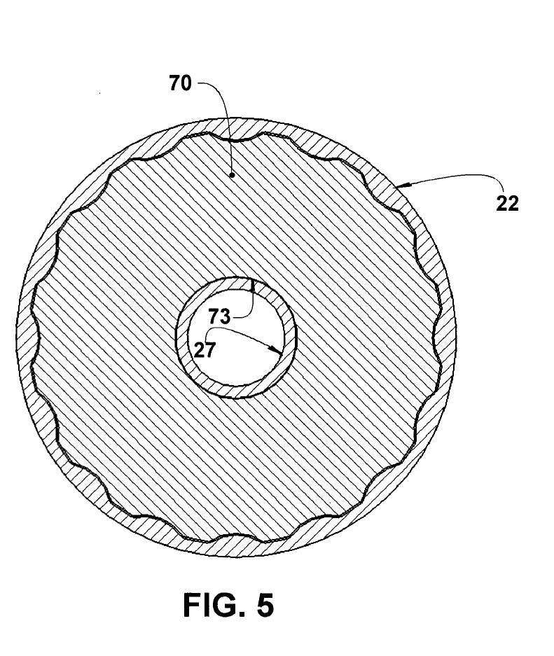

FIG. 6 represents an enlarged view of the upper portion of the filter illustrated in FIG. 4, with the housing and filter element being only partially illustrated; and

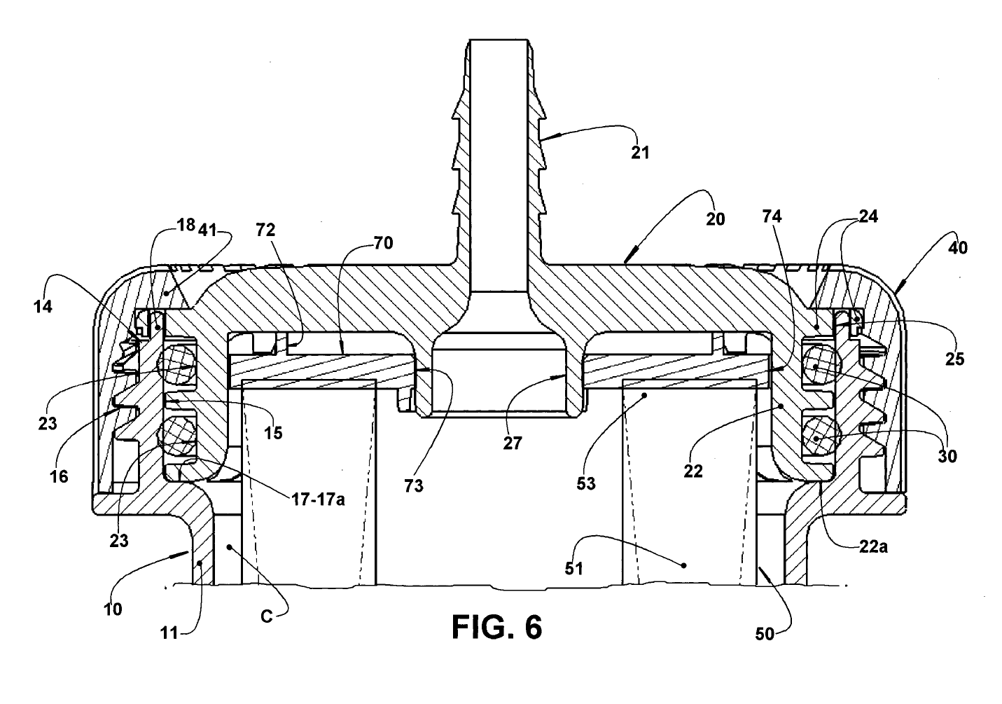

FIG. 7 represents an enlarged view of the bottom of the filter illustrated in FIG. 4, with the housing and filter element being only partially illustrated.

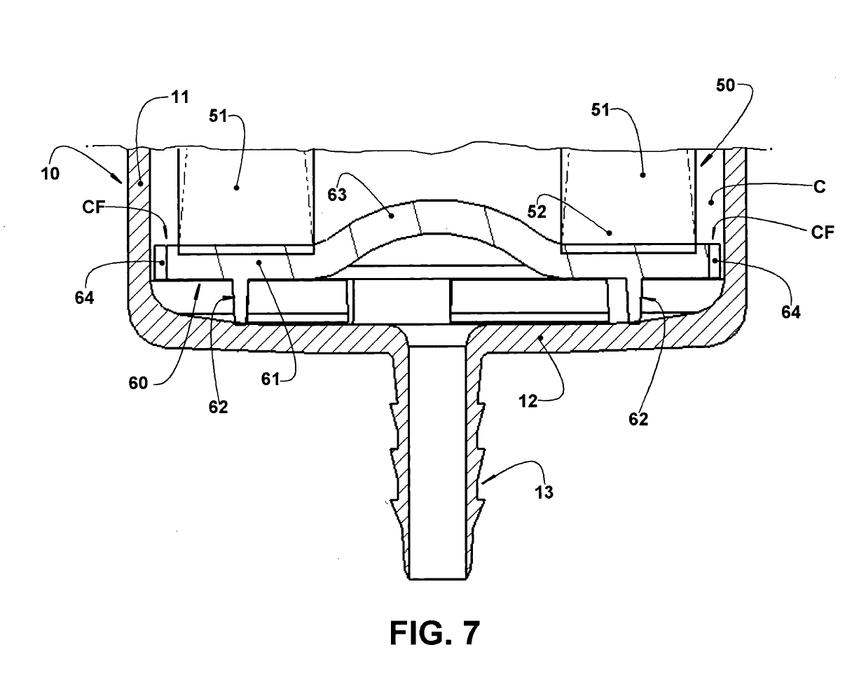

### DESCRIPTION OF THE INVENTION

As already mentioned, the present fuel filter is of the type comprising a housing 10 built in any suitable material, such as polyamide or even in metal sheet, having a tubular lateral wall 11 and a closed end wall 12 which incorporates, preferably in a single piece, an inlet nozzle 13 projecting axially outwards from the closed end wall 12 and being externally configured as a “fishbone”, in order to be easily introduced into an adjacent end of a fuel feed piping (not illustrated) which is normally made of rubber or like material.

The housing 10 further presents an open end 14 opposite to the closed end wall 12 and which is preferably defined by an enlarged cylindrical nozzle 15 provided with an outer thread 16. Said open end 14 is further provided with a stop means 17, defined by an annular step 17a, which is formed by the enlarged cylindrical nozzle 15 inside the tubular lateral wall 11 of the housing 10.

The present filter further comprises a lid 20 hermetically retained against the open end 14 of the housing 10 and incorporating, preferably in a single piece, an outlet nozzle 21 which projects axially outward and is externally configured as a “fishbone”, in the same way and for the same reason already described in relation to the inlet nozzle 13. The “fishbone” construction of the inlet nozzle 13 and outlet nozzle 21 allows their easy retention inside the respective sections of the fuel feed piping, with the help of simple tightening rings or clamps (not illustrated) provided around the piping sections telescopically fitted over said inlet nozzle 13 and outlet nozzle 21.

As illustrated, the lid 20 built in injected plastic material, such as polyamide or other adequate material, incorporates a peripheral skirt 22 hermetically fitted inside the enlarged cylindrical nozzle 15 and having an end edge 22a seated against the stop means 17 which, in the illustrated embodiment, takes the form of the annular step 17a. It should be understood that the lid 20 may present forms other than the one illustrated, as long as it can be seated and retained against a stop means 17 defined on the open end 14 of the housing 10, which stop means may be defined by means other than the one formed by the annular step 17a. For example, the stop means 17 could be defined by the upper edge itself of the open end 14 of the housing 10.

Still according to the illustrated embodiment, the peripheral skirt 22 of the lid 20 is externally provided with at least one circumferential rib 23 housing a sealing means 30 in the form of an elastic ring, which cooperates with the confronting region of the enlarged cylindrical nozzle 15.

It should be understood that the sealing means 30 may be built in different manners, as long as it is carried by at least one of the parts defined by the open end 14 of the housing 10 and by the lid 20, in order to be seated against the other of said parts, assuring the adequate tightness of the closure of the open end 14 of the housing 10 by the lid 20.

The enlarged cylindrical nozzle 15 may incorporate a plurality of end axial tongues 18 spaced apart from each other, the lid 20 incorporating an external circumferential flange 24 provided with a plurality of windows 25, inside each window being fitted a respective end axial tongue 18 of the enlarged cylindrical nozzle 15, upon the assembly of the lid 20 on the open end 14 of the housing 10.

The present filter further comprises a nut 40 to be engaged to said outer thread 16 and to the lid 20, in order to keep the latter hermetically seated and retained against the stop means 17, that is, to keep an outer edge 22a of the peripheral skirt 22 of the lid 20 seated against the annular step 17a. The nut 40 incorporates, in an end opposite to the annular step 17a, an inner circumferential flange 41, which is seated on the peripheral region of the lid 20, usually defined by the outer peripheral flange 24 of the lid 20, in order to allow that, by means of the tightening of the nut 40, the lid 20 is pressed against the stop means 17 and maintained hermetically fitted thereto by actuation of the sealing means 30 against the confronting internal regions of the enlarged cylindrical nozzle 15 of the housing 10.

The fuel filter further comprises a filter element 50 of tubular shape, having a peripheral wall 51 whose radial thickness defines a filtration means, usually made of filter paper, and through which the fuel is filtered in an inward radial trajectory.

The filter element 50 is housed inside the housing 10, defining, therewith, an annular chamber C for fuel admission, the filter element 50 having a closed first end 52, and a second end 53, which is seated against the lid 20 and communicates the interior of the filter element 50 with the outlet nozzle 21 of the lid 20.

According to the preferred illustrated embodiment, the first end 52 of the filter element 50 is closed by a blind flange 60, usually built in plastic material and comprising: an annular portion 61 which is hermetically incorporated, preferably by thermofusion, to the adjacent end of the peripheral wall 51 of the filter element 50 and carrying spacing axial projections 62 seated against the closed end wall 12 of the housing 10; and a central cap 63 curved inwardly to the filter element 50 and axially aligned with the inlet nozzle 13.

The annular portion 61 of the blind flange 60 defines, peripherally and together with a confronting portion of the tubular lateral wall 11 of the housing 10, a fluid communication CF between the inlet nozzle 13 and annular chamber C of fuel admission.

The blind flange 60 defines a single piece which completely seals the adjacent first end 52 of the filter element 50, having the central cap 63 thereof being configured and positioned in order to operate as a deflector for the fuel flow entering inside the housing 10, driving this flow radially outwards, towards the peripheral region of the blind flange 60 and to the fluid communication CF with the annular chamber C.

In the illustrated construction, the blind flange 60 has a peripheral contour slightly smaller than the inner peripheral contour of the confronting portion of the tubular lateral wall 11 of the housing 10, the fluid communication CF between the inlet nozzle 13 and the annular chamber C being obtained by a plurality of peripheral radial recesses 64 provided on said annular portion 61 of the blind flange 60.

The second end 53 of the filter element 50 is closed by an annular flange 70 which is hermetically incorporated, preferably by thermofusion, to the adjacent end of the peripheral wall 51 of the filter element 50.

The annular flange 70, preferably built of injected plastic material, carries spacing axial projections 72, seated against the lid 20 and presenting a central orifice 73, open to the interior of the filter element 50 and to the outlet nozzle 21, said annular flange 70 having a peripheral edge 74 which is seated, in a tight and hermetic manner, against a confronting inner portion of the peripheral skirt 22 of the lid 20.

In order to guarantee the tightness of the connection between the interior of the filter element 50 and the outlet nozzle 21, the lid 20 incorporates an inner tubular neck 27 which is dimensioned and configured to be tightly fitted in the central orifice 73 of the annular flange 70 of the filter element 50, the inner tubular neck 27 being open to the inside of the outlet nozzle 21 through the lid 20.

While only one embodiment of the present invention has been illustrated herein, it should be understood that alterations can be made in the form and disposition of the component parts, without departing from the constructive concept defined in the claims that accompany the present disclosure.

1. A fuel filter, comprising: a housing (10) having a tubular lateral wall (11), a closed end wall (12) incorporating an inlet nozzle (13), and an open end (14); a lid (20) hermetically retained against the open end (14) of the housing (10) and incorporating an outlet nozzle (21); and a tubular filter element (50) having a peripheral wall (51) defining a filtration means and being housed inside the housing (10) to define, together with the tubular lateral wall (11) of the latter, an annular fuel admission chamber (C), said filter element (50) having a first closed end (52), and a second end (53) which is seated against the lid (20) and communicates the interior of the filter element (50) with the outlet nozzle (21) of the lid (20, said filter being characterized in that the housing (10) has the open end (14) thereof provided with an outer thread (16) and with a stop means (17) against which the lid (20) is seated, at least one of the parts, defined by the open end (14) of the housing (10) and by the lid (20), carrying a sealing means (30) seated against the other of said parts, the filter further comprising a nut (40) to be engaged to said outer thread (16) of the housing (10) and to the lid (20), maintaining the latter hermetically seated on the housing (10) and retained against the stop means (17).

2. The fuel filter, as set forth in claim 1, characterized in that the first end (52) of the filter element (50) is closed by a blind flange (60) which is formed: by an annular portion (61) incorporated to the adjacent end of the peripheral wall (51) and carrying spacing axial projections (62) seated against the closed end wall (12) of the housing (10); and by a central cap (63) curved inwards the filter element (50) and axially aligned with the inlet nozzle (13), said annular portion (61) defining, peripherally and together with a confronting portion of the tubular lateral wall (11) of the housing (10), a fluid communication (CF) between the inlet nozzle (13) and the annular chamber (C) of fuel admission.

3. The fuel filter as set forth in claim 2, characterized in that the annular portion (61) of the blind flange (60) presents a peripheral contour slightly smaller than the inner peripheral contour of the confronting portion of the tubular lateral wall (11) of the housing (10), the fluid communication (CF) between the inlet nozzle (13) and the annular chamber (C) being obtained by a plurality of peripheral radial recesses (64) provided on said annular portion (61.

4. The closure device, as set forth in any of claim 2 or 3, characterized in that the annular portion (61) of the blind flange (60) is hermetically thermofused to the adjacent end of the peripheral wall (51) of the filter element (50).

5. The fuel filter, as set forth in claim 2, characterized in that the housing (10) has its open end (14) defined by an enlarged cylindrical nozzle (15) provided with an outer thread (16), the stop means (17) being defined by an annular step (17a), which is formed by the enlarged cylindrical nozzle (15) inside the housing (10), the lid (20) being provided with a peripheral skirt (22) which is hermetically fitted inside the enlarged cylindrical nozzle (15) and having an end edge (22a) seated against the annular step (17a).

6. The fuel filter, as set forth in claim 5, characterized in that the peripheral skirt (22) of the lid (20) is externally provided with at least one circumferential rib (23) housing a sealing means (30) in the form of an elastic ring, which cooperates with a confronting region of the enlarged cylindrical nozzle (15).

7. The fuel filter, as set forth in claim 5, characterized in that the enlarged cylindrical nozzle (15) incorporates a plurality of end axial tongues (18) spaced apart from each other, the lid (20) incorporating an external circumferential flange (24) provided with a plurality of windows (25), inside each window (25) being fitted a respective end axial tongue (18) of the enlarged cylindrical nozzle (15) upon the assembly of the lid (20) on the open end (14) of the housing (10).

8. The fuel filter, as set forth in any of claim 6 or 7, characterized in that the nut (40) incorporates, in an end opposite to the annular step (17a), an inner circumferential flange (41), which is seated on the peripheral region of the lid (20).

9. The fuel filter, as set forth in claim 8, characterized in that the second end (53) of the filter element (50) is closed by an annular flange (70) which is incorporated to the adjacent end of the peripheral wall (51) of the filter element (50) and which carries spacing axial projections (72) seated against the lid (20) and presenting a central orifice (73) open to the interior of the filter element (50) and to the outlet nozzle (21), said annular flange (70) having a peripheral edge (74) which is seated, in a tight and hermetic manner, against a confronting inner portion of the peripheral skirt (22) of the lid (20).

10. The fuel filter, as set forth in claim 9, characterized in that the lid (20) incorporates an inner tubular neck (27) which is tightly fitted in the central orifice (73) of the annular flange (70) of the filter element (50) and open to the inside of the outlet nozzle (21).

11. The fuel filter, as set forth in any of the preceding claims, characterized in that the inlet nozzle (13) and the outlet nozzle (21) are externally shaped as a “fishbone”.
